(19) United States
(12) Patent Application Publication
(10) Pub. No.: US 2010/0121719 A1
(43) Pub. Date: May 13, 2010

(54) MOBILE SCRATCH OFF ADVERTISING SYSTEM

(75) Inventors: Titus Orion Blair, Saint Augustine, FL (US); William Terrett Rogers, The Woodlands, TX (US); Maelene Laura Beauhall, The Woodlands, TX (US)

Correspondence Address: Edmonds Nolte, PC, 16815 ROYAL CREST DRIVE, SUITE 130, HOUSTON, TX, 77058, US

(73) Assignee: MOBILE THUNDER, LLC, The Woodlands, TX (US)

(21) Appl. No.: 12/395,181

(22) Filed: Feb. 27, 2009

Related U.S. Application Data
(60) Provisional application No. 61/198,928, filed on Nov. 10, 2008.

(51) Int. Cl. G06Q 30/00

(52) U.S. Cl. 705/14.64

(57) ABSTRACT

Embodiments of the disclosure may provide a method, system, and computer program configured to display advertising to mobile user. The method may include uploading logon information from a mobile device to a server, wherein the logon information contains at least a geographical location identifier, downloading a current electronic scratch off game to the mobile device from the central server, wherein the current electronic scratch off game corresponds to the geographical location identifier, displaying a foreground image to a user of the mobile device, and receiving a wiping input from the user of the mobile device on a touch screen of the mobile device. The method may further include removing a portion of the foreground image corresponding to the wiping input, displaying background image in areas corresponding to the wiping input, displaying a win or loss indicator, and using the win indicator at a retail sponsor advertising location to obtain a prize or item of value.

### BACKGROUND

This application claims the benefit of the filing date of U.S. Provisional Patent Application Ser. No. 61/198,928, which was filed on Nov. 10, 2008. This priority application is hereby incorporated by reference in its entirety into the present application, to the extent the priority application is not inconsistent with the present application.

A scratch card, which is often referred to as a scratch off, scratch ticket, scratch game, scratch-and-win or instant game, is generally described as a small device that is usually made of a disposable material, such as paper, cardstock, or cardboard, where one or more areas of the device contain concealed information. Generally the concealed information is printed on the device in some manner and is subsequently covered by a substance, such as a latex material, that cannot be seen through, but can be scratched off by the user of the device. Applications for scratch cards include gambling, lottery games, quizzes, and to conceal PINs for telephone calling cards and other prepaid-type services. In some cases, the entire scratchable area is removed or scratched to determine if a prize has been won, or to reveal the secret code. Generally, the result for the device holder does not change based on what portions are scratched off or not. In other cases, selected areas have to be scratched to win.

However, these conventional scratch cards or devices are extremely vulnerable to attack, as technology and devices exist that allow hackers to see through the concealing substance without physically disturbing it. Additionally, conventional scratch cards require a brick and mortar distribution, which increases overhead and limits distribution bandwidth. Further, conventional scratch cards are not environmentally friendly, as they are discarded once used. Finally, although conventional scratch cards are very popular, they do not provide any sort of targeted advertising for their sponsors other than to only sell scratch cards manufactured for specific geographic areas, which is not cost effective. Therefore, there is a need in the art for a method or software package that allows for mass electronic distribution of scratch cards with targeted advertising.

### SUMMARY OF THE DISCLOSURE

Embodiments of the disclosure may provide a method for displaying advertising to mobile user. The method may include uploading logon information from a mobile device to a server, wherein the logon information contains at least a geographical location identifier, downloading a current electronic scratch off game to the mobile device from the central server, wherein the current electronic scratch off game corresponds to the geographical location identifier, displaying a foreground image to a user of the mobile device, and receiving a wiping input from the user of the mobile device on a touch screen of the mobile device. The method may further include removing a portion of the foreground image corresponding to the wiping input, displaying background image in areas corresponding to the wiping input, displaying a win or loss indicator, and using the win indicator at a retail sponsor advertising location to obtain a prize or item of value.

Embodiments of the invention may further provide a computer program embodied on a computer readable medium, that when executed by a processor, is configured to control a method for displaying advertising content to a mobile user. The computer controlled method may include uploading logon information from a mobile device to a central server, wherein the logon information contains a geographical location identifier, downloading a current electronic scratch off game to the mobile device from the central server, wherein the current electronic scratch off game corresponds to the geographic location identifier, and displaying a foreground image to a user of the mobile device. The computer controlled method may further include receiving a wiping input from the user of the mobile device on a touch screen of the mobile device, removing a portion of the foreground image corresponding to the wiping input, displaying background image in areas corresponding to the wiping input, displaying a win or loss indicator, and using the win indicator at a retail sponsor advertising location to obtain a prize or item of value.

Embodiments of the invention may further provide a method for displaying targeted advertising to a user of a mobile device. The method may include receiving a logon request from the mobile device in an advertising server, wherein the logon request includes a mobile device ID and geographic location information for the mobile device, validating the logon request in the advertising server, and in response to the validating, sending a geographically specific scratch off game from the server to the mobile device, wherein the scratch off game includes a unique package ID, and receiving the scratch off game and the unique package ID in the mobile device, and validating the scratch off game by comparing the received unique package ID with a locally stored game package ID. The method may further include, upon successful validation of the scratch off game, allowing the user to play the game, which may include displaying a foreground image to the user on a touch screen display of the mobile device, and receiving a touch screen input on the mobile device and removing the foreground image in an area where the touch screen input was received, thus revealing portions of a background image, which may reveal if the game contains a win or loss indicator.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates a flowchart for an exemplary method for providing a scratch or rub off game to a mobile user;

FIG. 2 illustrates a flowchart further detailing an exemplary logon or initialization process for an exemplary method of the invention;

FIG. 3 illustrates a flowchart further detailing an exemplary game play process for an exemplary method of the invention;

FIG. 4 illustrates a flowchart further detailing an exemplary prize claim process for an exemplary method of the invention; and

FIG. 5 illustrates and exemplary system configuration of the disclosure.

### DETAILED DESCRIPTION

It is to be understood that the following disclosure provides several different exemplary embodiments or examples for implementing different features of various exemplary embodiments of the invention. Although some specific examples of components, arrangements, configurations, etc. are described below to simplify the present disclosure, these examples and exemplary embodiments are, of course, merely examples and are not intended to be limiting upon the scope of the invention. Additionally, the present disclosure may repeat reference numerals and/or letters in the description or figures related to the various exemplary embodiments of the invention. However, this repetition is for the purpose of simplicity and clarity and does not in itself dictate a relationship between the various exemplary embodiments and/or configurations described herein. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

The same applies for software processes, method steps, and procedures described herein, i.e., the order of the steps or processes illustrated in exemplary embodiments is not intended to be limiting in that additional steps may be interstitially inserted or positioned without departing from the scope of the invention. Further, unless specifically recited in a claim, where method steps or processes are described, embodiments of the invention are not intended to be limited to any particular order of method steps, as variations on the exemplary step or process sequences are contemplated within the scope of the invention. More particularly, the inventors contemplate that the method steps and/or processes described in the following exemplary embodiments may be conducted in any order and may include a mix of steps from a plurality of exemplary embodiments in any order.

Additionally, in the following, reference is made to various embodiments of the invention. However, it should be understood that the invention is not limited to any of the specifically described embodiments. Rather, the invention may include any combination of the features and elements described in the various exemplary embodiments, whether related to different embodiments or not. Furthermore, in various exemplary embodiments, the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered express elements or limitations of the appended claims, except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention may be implemented as a program product for use with a computer system or other data or instruction processing-type system, device, or apparatus, which may include any type of mobile or portable device capable of storing a program, executing processing instructions, and displaying a result to a user. The program(s) of the program product may define functions of the embodiments (including the methods described herein) and may be contained on a variety of computer-readable media. Illustrative computer-readable media include, but are not limited to: (i) information permanently stored on non-writable storage media (e.g., read-only memory devices within a computer, a server, network, mobile device, etc.) (ii) writable/alterable information stored on writable storage media (e.g., CD-ROM disks, zip disks, hard-disk drives, tape drives, flash memory, and any other writable computer storage medium known in the art); or (iii) information conveyed to a computer or wireless device by a communications medium, such as through a computer network, wireless network, optical network, radio network, or any other network traditionally used to communicate between computers, servers, or mobile devices. The latter embodiment specifically includes information transmitted to/from the Internet and/or other wireless networks, such as those networks used to communicate with mobile phones and other hand held computing devices.

In general, the routines executed to implement the embodiments of the invention, may be part of an operating system or a specific application, component, program, module, object, or sequence of instructions. The computer program of the present disclosure typically includes a multitude of instructions that will be translated by the native computer into a machine-readable format, and hence the instructions are transformed into executable instructions. Also, programs generally include variables and data structures that either reside locally to the program or are found in memory or on storage devices in communication with the computer system or processor. Additionally, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

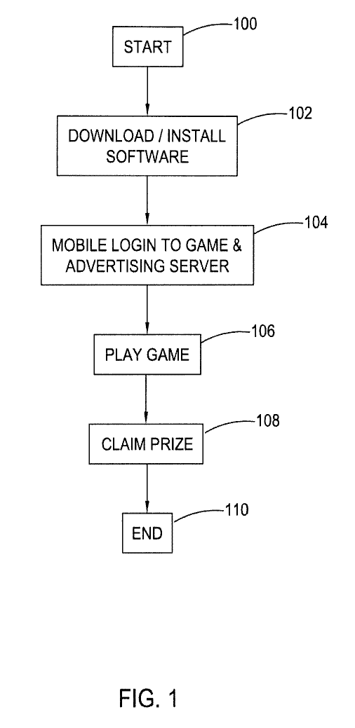

FIG. 1 illustrates a flowchart for an exemplary method for providing a scratch or rub off game to a mobile device, wherein the scratch or rub off game includes a dynamically generated advertising component. For purposes of the exemplary method, a mobile device may generally be defined as a hand held or pocket-sized computing device that typically includes a display screen with touch input and/or a miniature keyboard. Mobile devices used in the present disclosure generally include wireless communication capability, such as analog or digital cellular or mobile phone-type communications, satellite communications, or other radio frequency-type communications. Exemplary mobile devices include a cell or mobile phone, a handheld electronic computing device, and a mobile organizer device or a personal or enterprise digital assistants (PDA).

Returning to the exemplary method illustrated in FIG. 1, the exemplary method begins at step 100 and continues to step 102, where a mobile device downloads and/or installs software configured to support the scratch or rub off game on the particular mobile device. The software may be downloaded through a wireless network, such as the wireless network used to support cell phone service or mobile Internet service in a typical mobile device, or alternatively, the software may be downloaded via a temporary hard connection between the mobile device and a network, server, or other data storage device configured to store and distribute the software.

Once the scratch off game software is installed and configured on the mobile device, the user of the mobile device activates the game at step 104. The mobile device executes a logon process with a game server and/or advertising server (further described herein). Once the mobile device is logged on to the respective servers, the method continues to step 106 where the user of the mobile device plays the game on the mobile device. However, in at least one embodiment of the invention, the mobile device does not need to be continually connected to the servers for a user to play the game. In some embodiments of the disclosure the user may be selectively allowed to play the game a plurality of times, and during each play of the game the user may have an opportunity to win a prize or other reward. In the event that the user wins during one of the game plays, the method continues to step 108 where the user is awarded and/or claims the prize for winning the game.

The process for awarding the prize may include providing a code, such as a coupon code or bar code, that allows the user to receive a discount on a future purchase. Other prize awarding processes may include crediting an account associated with the user of the mobile device with a point or monetary value that may be used to obtain goods, services, or discounts at specified merchants. Once the user has played the game and claimed a prize, the user may either continue to play the game, assuming that the game has not expired, or the user may stop playing and end the game, as noted at step 110 in the exemplary flowchart. The applicants note that each game downloaded may include an internal expiration, which may be tracked using the game ID mentioned herein. Thus, the server may exercise control over the use of the game by expiring the game ID associated with a particular mobile device. The local MDOS of the mobile device may also use an internal counter to determine and track the number of times that a particular game has been played by the user. As such, each individual game downloaded by the mobile device may include a predetermined expiration game count, that when reached, disables the game for further play. Thus, if a game has an expiration game count of 10, then the user may be allowed to play the game 10 times, i.e., until the MDOS's internal counter reaches 10.

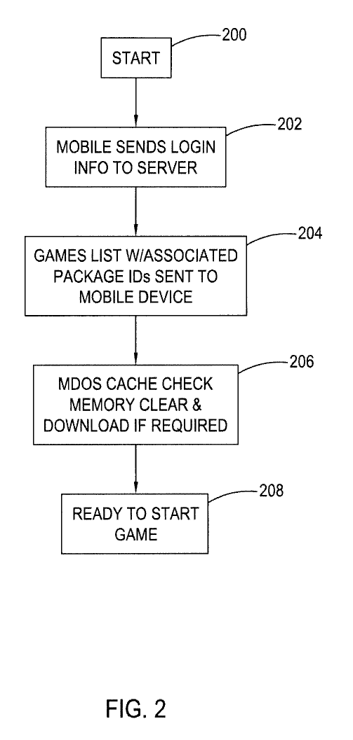

FIG. 2 illustrates a flowchart further detailing an exemplary logon or initialization process for an exemplary method of the invention. The exemplary method illustrated in FIG. 2 begins at step 200 and continues to step 202, where the mobile device sends logon information to the game and/or advertising server. The logon information may include, for example, a mobile device ID, a username and/or password for the server network, and/or geographical location information/identifier, which may include GPS coordinates, longitude and latitude, cell tower proximity, or other location information that may be determined or triangulated using conventional mobile phone signal transmission technologies.

The logon information is received by the server network and authenticated. Once the logon information is authenticated, the method continues to step 204, where an updated games list and the associated package IDs are sent to the mobile device from the server network. For example, upon successful logon, the server network may send the list of current games with a package ID associated with each game back to the mobile device. The server network may further send a list of available games based upon the geographic location of the mobile device, which may be determined from GPS coordinates, cell site triangulation, user input, or other known location determination methodologies. If any of the games on the mobile device are out of date or expired (outdated or mismatched package or game ID), then the game associated with the respective ID may be expired or otherwise rendered unavailable to play or to win a valid prize. Further, the server may use the geographic location identifier to select a particular game that is configured for the specific location within which the mobile device is operating. For example, when the server receives the geographic location identification information from a mobile device, the server may select a scratch off game from the database of games available, where the selected scratch off game is configured to provide targeted advertising for the specific geographic location where the mobile device is operating. As such, the system and methodology of the present disclosure allows for advertisers to target specific geographic areas which may be proximate to the advertisers brick and mortar location.

With regard to determining the geographic location of a mobile device, a cell site is a term used primarily in North America for a site where antennas and electronic communications equipment are placed to create a cell in a mobile phone or wireless data network. A cell site is generally composed of a tower or other elevated structure for mounting antennas, and one or more sets of transmitter/receivers transceivers, digital signal processors, and control electronics, a GPS receiver for timing (for CDMA2000 or IS-95 systems). In GSM networks, cell sites are often referred to as Base Transceiver Stations (BTS). When a mobile device is operating, the device is generally communicating with a primary cell site, however, the mobile device is often communicating with several other secondary cell sites as well. The term handoff or handover refers to the process of transferring an ongoing call or data session from one cell site to another cell site, and this may generally occur when the mobile device is moving through a geographic area. When cell sites communicate with mobile devices, there is an exchange of information, which may include identification numbers for the devices, data or voice sessions in progress, etc. Additionally, the exchanged information may include signal strength, and since multiple cell sites may communicate with a single mobile device, the signal strength from multiple cell sites may be used to determine or approximate a mobile device's geographic location via triangulation. Similarly, if the mobile device is GPS enabled, the GPS coordinates may be exchanged with the cell site. Thus, in areas or on devices where GPS location is not available, cell sites may be used in embodiments of the present disclosure to provide relatively accurate geographic location information for the mobile device so that the advertising server can select appropriate content to send to the mobile device.

Returning to the discussion of FIG. 2, the information sent from the server network to the mobile device is received by the mobile device and processed by the mobile device operating system (MDOS), as noted at step 206. In at least one exemplary embodiment of the disclosure, the MDOS may be configured to check the local cache of games resident on the mobile device based upon the package IDs associated with the individual games to determine if the package IDs of the cached games differ from those just received from the server network. In the event that a package ID for a particular game does not match, then the mobile device may be configured to clear the older version of the game from the cache memory and download and install the most recent version of the game (having the most recent package ID).

Individual game configurations may be dependent upon package IDs, and as such, one novel feature of the present disclosure is to dynamically populate mobile devices with games having particular (new and updated) package IDs. For example, a particular game having a particular package ID may be configured for use in a specific geographic area, in that the game may have prizes or rewards that are targeted to a particular geographic area. Further, each game may also have location specific advertising associated therewith, and as such, the present disclosure may utilize the game package IDs to ensure that users playing the game in a particular geographic area will be exposed to relevant advertising and will have the opportunity to win or receive geographically relevant prizes, coupons, or discount codes. Returning to the discussion of the exemplary method illustrated in FIG. 2, once the mobile device has logged on to the server network, been validated, and has received the appropriate game package, the exemplary method may continue to step 208, where the user is able to start playing the game.

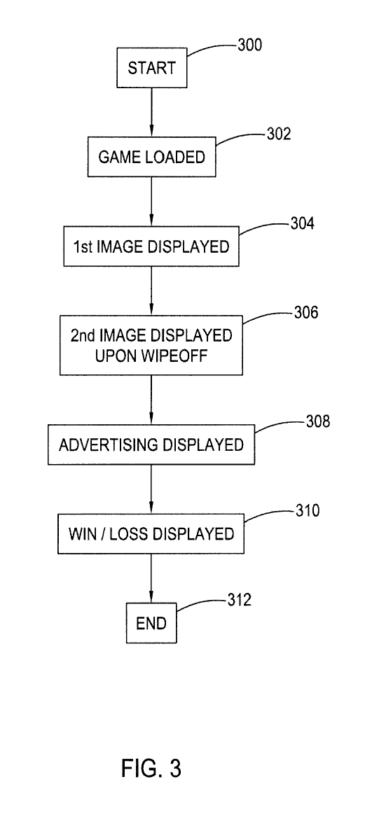

FIG. 3 illustrates a flowchart further detailing an exemplary game play process for an exemplary method of the invention. The exemplary method illustrated in FIG. 3 begins at step 300 and continues to step 302 where the game is loaded locally on the mobile device. Loading the game, as is generally known in the art, may include reading a plurality of software instructions from a memory resident on the mobile device, wherein the software instructions are configured to support the operation of the game. This process may continue throughout the game as necessary.

During the process of playing the game, two images are simultaneously displayed, with one image in the background and generally not viewable by the user initially. The second image, which is the forefront or foreground image, is viewable by the user. Thus, at step 304 of the exemplary method, the first image or the forefront image is displayed to the user. The method continues to step 306, where the user wipes, rubs, or scratches the screen of the mobile device to display at least a portion of the underlying background image. Thus, at step 306 a mobile device that includes a touch screen input and output device may be configured to display the foreground image to the user, and then remove the foreground image on the display screen for every location where the user touches the display screen. As such, if the user were to wipe their finger across the screen, the resulting display would wipe away the foreground image in the same area where the user touched or wiped the screen. In the area were the user touched or wiped the screen, the background image will be displayed and the foreground image will be removed or cleared in that particular area. Thus, the user may essentially wipe away the entire foreground image by touching the entire surface area of the screen at various times to reveal or display the background image.

The background image may generally include a game result, prize indication, and/or an advertisement. More particularly, in embodiments of the invention where the method may be used to provide an automated scratch off game card, then the foreground image may be used to represent the scratch off material and the background image may be used to represent the image displayed to the user of a scratch off card once the scratch off material is removed. Thus, the background image may include a prize indication if the scratch off card, i.e., the electronic game, is a winner.

In at least one exemplary embodiment of the invention, the background and/or foreground images displayed to the user of the mobile device may include a targeted advertising component. More particularly, as noted above, the exemplary method of the invention may include providing a geographical indicator to the advertising and/or game server of the exemplary system of the invention. This geographical information may be used by the system of the invention to provide targeted advertising and/or game rewards or prizes to the users based upon the geographic location of the mobile device when the game is being played. For example, if the user of the game is close to a particular retail outlet, such as a coffee shop, then the prize or coupon given to the user upon winning the scratch off game may be a coupon for a discounted item or a free item at the respective coffee shop to which the user of the mobile device is geographically proximate. This allows the game provider to sell targeted advertising that has been shown to generate higher percentages of customer response to the advertising for scratch off or rub off games.

Returning to the discussion of FIG. 3, at step 308 the advertising component of the game may be displayed to the user. The advertising component may be displayed after the user wipes off the foreground image along with the win or loss information. However, in other exemplary embodiments of the invention, the advertising may also be displayed to the user in the foreground image prior to the wipe off process. In yet another exemplary embodiment, the advertising component may be displayed in a banner type mode during various stages of the game. Additionally, as noted above, the advertising displayed to the user of the mobile device generally comprises targeted advertising, i.e., the advertising may be selected based upon at least the geographic location of the mobile device. In other exemplary embodiments of the invention, the advertising may be selected in accordance with the mobile device user's profile. For example, the user of a mobile device may be asked to enter information in order to access the games, and this information can be used to select targeted advertising for the particular user. For example, in order to activate the games on a particular mobile device, the user may be required to enter basic financial information, geographic information, demographic information, personal interest information, or any other information that may be useful to an advertiser in selecting a targeted advertising audience.

Once the user wipes off at least a portion of the foreground image, the method continues to step 310, where win/loss information may be displayed to the user. Win/loss information may include coupons, discount codes, point or monetary values to be added to a winner's account, or any other prize or incentive that a particular advertiser may desire to offer to a game player. Once the win/loss information is displayed to the user at step 310, the user may continue to play the game if the particular game has not expired or run out of attempts available, or the user may discontinue playing the game and the exemplary method may end at step 312.

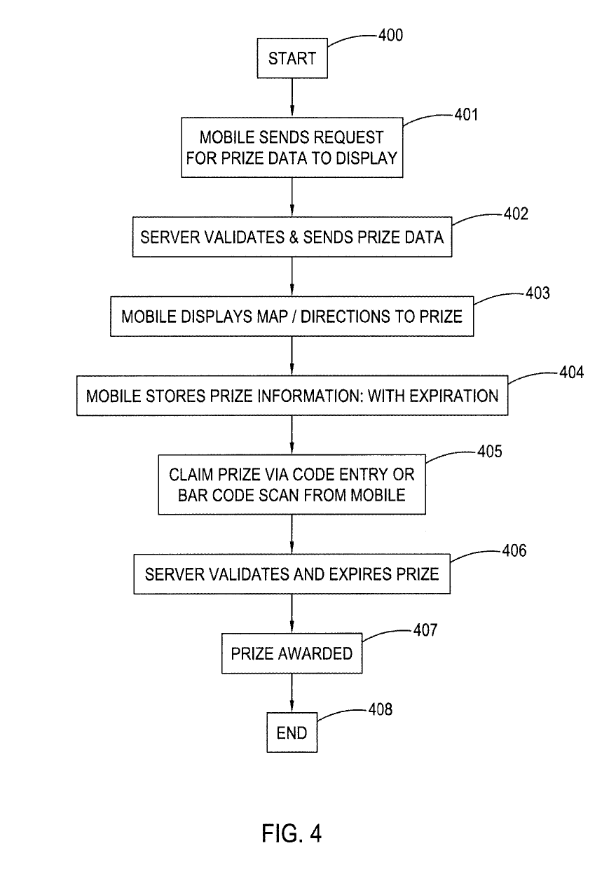

FIG. 4 illustrates a flowchart further detailing an exemplary prize claim process for an exemplary method of the invention. The method begins at step 400 and continues to step 401, where the mobile device sends a request to the game and/or advertising server for prize data to be displayed on the screen for a selected prize in the prizes won area of the application. The advertising and/or prize server may validate the request and send back prize data to the mobile device if the prize is not yet claimed. For example, the advertising and/or prize server may generally check to determine that the game is not issuing the same prize to multiple players such that a prize budget for a particular advertiser or contributor may be managed and controlled. The prize data is received from the advertising and/or game server by the MDOS, which may then display geographic information, such as a map or address, where the winner can claim a particular prize won in the game. Further, for mobile devices that are GPS enabled, the method of the invention may further include providing directions to the location where the prize can be claimed, as described in step 403 of the exemplary method.

Thus, once the game prize is determined and displayed to the user, the user may either claim the prize at the sponsoring location, or store the prize in memory on the mobile device, as noted at step 404 of the exemplary method. In embodiments of the invention where the user chooses to redeem the prize, the user may proceed to the retail location sponsoring the prize using the provided directions. Once at the retail location, the user may present a prize code (display the code on the mobile devices screen) or other identifying indicia that is associated with a particular prize, as noted at step 405 in the exemplary method. In another exemplary embodiment, the mobile device may be configured to display a bar code on the screen of the mobile device, and the retail location may scan in the displayed barcode to facilitate the prize redemption process. Regardless of the redemption method, generally the prize code or bar code used to redeem the prize is predetermined, i.e., the prize codes are generally set up by the sponsor retail locations with the advertising and/or game servers so that the validity and authenticity of the game and its winners can be monitored and controlled throughout the entire methodology. Thus, once a prize code or bar code is presented to the retail location, the retail location will generally have a computer or other electronic terminal configured to communicate with a validation source for the prize or bar code. For example, a retail location may have the prize or barcodes programmed into their merchandising systems such that when a barcode or prize code is presented it can be validated against the retail locations own records for prizes to be distributed.

In another exemplary embodiment, the retail location may communicate with the game server or the advertising server of the present disclosure to validate the prize won. In this embodiment, a terminal at the retail location may send information such as prize data, an encrypted identification number, an encrypted mobile device identification number, geographic information, or sponsor redemption code-type information to the advertising and/or game server to validate the prize being claimed. The advertising/game server may then validate the prize being claimed and expire the prize on the respective servers so that a secondary claim of the same prize cannot take place. The servers may then send the validation back to the retail location to facilitate distribution of the retail prize. Regardless of the validation method, once the prize is validated by the servers and transmitted back to the retail location, the method continues to step 407 where the retail location awards the prize, and the method ends at step 408.

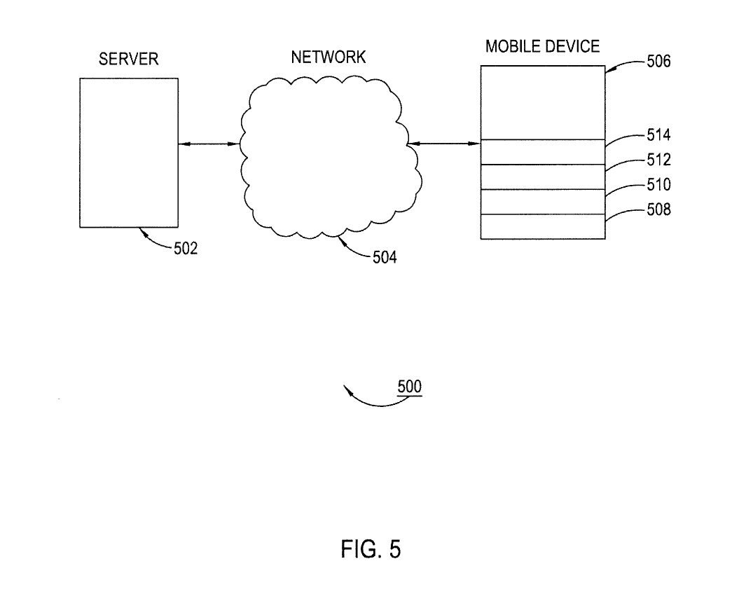

FIG. 5 illustrates an exemplary system configuration 500 for an exemplary embodiment of the disclosure. The exemplary system 500 generally includes a server 502 which may be configured to store advertising information, game information, and download information. The server 502 may further be configured to serve or download the information stored thereon to various mobile devices 506. The exemplary server 502 may be in communication with a network 504, wherein the network 504 is configured to communicate between various mobile devices 506 and the server 502. The network 504 may be any type of data or voice communication network, such as a satellite network, cellular network, digital network, or other type of wireless or wired network. Further, the network 504 will generally be configured for bidirectional communication between the server 502 in the various mobile devices 506. The network 504 is generally in communication with at least one mobile device 506. The mobile device 506 includes a plurality of internal components, including, but not limited to the MDOS 508, a processor 510 configured to execute software instructions, and memory device 512 configured to store a software program or data thereon, and at least one I/O device 514, which for purposes of the present disclosure may include a touch screen display.

In operation, the exemplary mobile device 506 may be used to communicate with the server 502 to download at least one game. When the user activates the game on the mobile device 506, the mobile device 506 may communicate with the server 502 to both validate the game and to communicate the geographic location of the mobile device at the time of the game to the server 502. The server 502 may communicate game, prize, and/or advertising information back to the mobile device 506 in accordance with the geographic information sent to the server 502 from the mobile device 506. The mobile device may then display a foreground image with a background image that is not visible behind the foreground image. The foreground image may contain an advertising component, wherein the advertising component is selected in accordance with the geographical location of the mobile device.

The user may touch at least a portion of the mobile device screen to wipe off the foreground image to reveal at least a portion of the background image. In revealing the background image, the user reveals whether or not the game has been won, and further, if there is a prize won in the game. If a prize is won, a coupon code or other redemption information may be displayed, and further, the mobile device may provide directions or other geographic information to the user to facilitate claiming of the prize immediately after playing the game. For example, the mobile device may display directions to the user of the mobile device to facilitate the user traveling to the nearest retail location of the prize sponsoring retail organization, thus facilitating the users immediate redemption of the prize won, and further, facilitating the user traveling directly to the retail outlet and becoming an advertising customer conversion.

Once the user of the mobile device is in the retail outlet, the prize won may be claimed by displaying a prize or coupon code on the screen of the mobile device, which may then be entered into the retail outlets merchandising system for redemption. In another exemplary embodiment of the invention, the mobile device may display a bar code corresponding to the prize won in the game, and the bar code may be scanned by the retail location to facilitate prize redemption. Upon redeeming the prize, the mobile device, the retail location, and the game servers cooperatively operate to validate the prize and to maintain the prize database such that duplicate prizes and or fraudulent activity can be eliminated.

In another exemplary embodiment, the prize may not be immediately claimed, and as such, the redemption information may be stored in the mobile device for future use. Much like conventional coupons and/or price reductions, the data associated with the redemption information may have an expiration date on it, and as such, the data may automatically erase itself from the mobile device's memory after an expiration period tolls. In other embodiments, the game may be configured for a running total or score related to the prizes won. For example, the exemplary game may be configured to keep a cumulative score of prizes, points, or other indicia of winning or value on the mobile device. This cumulative score may then be used at some point in time to receive prizes, coupons, discounts, etc., much like a conventional frequent point or frequent flyer type account is used.

In another exemplary embodiment of the disclosure, the software, method, and/or system of the disclosure may be used to play a lottery or lottery-type game on the handheld device. In similar fashion to previous described methods, the lottery game may be downloaded to the handheld device from a central server and played locally on the device. The central server may utilize tracking and monitoring functions to randomly select the numbers for the game and may send the winning game ticket to a random user. In other exemplary embodiments the central server may use predetermined parameters to select a user to send the winning lottery ticket to, wherein the predetermined parameters may include geographic location, a point value assigned to a particular user or mobile device, where the point value corresponds to frequency of use of the game or advertising service or another customer related factor such as purchasing at a particular retailer or purchasing a particular type of product.

In another exemplary embodiment of the disclosure, the method or software of the disclosure may be configured to allow a player to earn points or credits for either playing or winning at the games, taking surveys that contribute information beneficial to advertisers, or participating in interactive processes on the handheld. The accumulated points or credits may then be redeemed at a retail location or on a website for products or services, i.e., the points may become a contribution to a greater point total needed to claim a prize, or may equate to or be exchanged for a product/prize at a sponsor or advertising retailer, for example.

In another exemplary embodiment of the disclosure, a sponsor may require that a player who has won a prize or points display some form of identification, such as a picture ID, drivers license, or credit card to claim the prize for winning a game at a retail location. This is slightly different from the previous exemplary embodiments where the mobile device was used to display a bar code that the retailer could scan to apply the discount or claim the prize. The possession of the ID or credit card would serve as a confirming method that allows for comparison with data on hand with the sponsor or retailer that that user has won a prize. Thus, in some exemplary embodiments of the invention, the mobile device and/or the central server may communicate with the sponsor/retailer's computer system to transmit data thereto. The data may be used to represent which players have won a game that involves the sponsor or retailer.

In another exemplary embodiment of the disclosure, the software or method of the disclosure may be configured to allow advertisers or sponsors to select or change the game odds or types of prizes awarded based on the location of the user device. In an exemplary embodiment of the disclosure the advertisers or sponsors may select or change the game odds or prizes based on any parameter or simply as a choice that is available to the sponsor, advertiser, or retailer. In at least one embodiment of the invention the game odds (odds of winning in any particular game) may be changed dynamically via communication with the game server by the retailer, advertiser, or sponsor. In other exemplary embodiments the game odds may be changed in accordance with predetermined parameters or algorithms that the advertisers or sponsors may set and program into the server so that the server may automatically change the odds of the games when the parameters are satisfied or met.

In another exemplary embodiment of the disclosure, the method or software of the disclosure may be implemented on mobile phones or handheld devices that do not use touch screens. Although the method and software of the disclosure may use the screen wiping function in some embodiments, the inventors contemplate that other methods for removing portions of the foreground image to reveal portions of the background image (the win loss indicator) may be used with out departing from the scope of the disclosure.

In another exemplary embodiment of the disclosure the software or methods of the disclosure may be available for playing on the web or internet, whereby the winners can print a coupon/certificate to present to the retailer.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A method for displaying advertising to mobile user, comprising:
receiving logon information from a mobile device in a game or advertising server network, wherein the logon information contains a geographic location identifier;
selecting, at the game or advertising server network, an electronic scratch off game corresponding to the geographic location identifier;
downloading the selected electronic scratch off game to the mobile device from the server;
displaying a foreground game image to a user of the mobile device;
receiving a wiping input from the user of the mobile device on a touch screen of the mobile device;
removing a portion of the foreground game image corresponding to the wiping input;
displaying a background game image in areas corresponding to the wiping input, wherein the background game image contains a scratch off game win or loss indicator; and
using the win indicator at a sponsor advertising location to obtain a prize or item of value.

2. The method of claim 1, wherein downloading the electronic scratch off game to the mobile device from the central server comprises checking a mobile device game identification value against a server game identification value, wherein the server game identification value is calculated based on the geographical location identifier.

3. The method of claim 1, wherein displaying the foreground image further comprises displaying an advertising component.

4. The method of claim 1, wherein displaying the background image comprises displaying an advertising component.

5. The method of claim 1, wherein the game win indicator comprises a discount code or a bar code configured to be scanned by an advertiser at a retail location.

6. The method of claim 1, further comprising expiring the electronic scratch off game after a predetermined number of plays is reached.

7. The method of claim 1, further comprising storing a compilation of win indicators in a memory of the mobile device so that the win indicators may be subsequently used.

8. The method of claim 1, wherein the logon information further comprises a mobile device ID, a username and password for the game or server network, and the geographic location identifier.

9. The method of claim 1, wherein the geographic location identifier comprises GPS coordinates, longitude and latitude information, or mobile device signal triangulation information.

10. A computer program embodied on a computer readable medium, that when executed by a processor, is configured to control a method for displaying advertising content to a mobile user, comprising:
uploading logon information from a mobile device to a central server, wherein the logon information contains a geographical location identifier;
downloading a current electronic scratch off game to the mobile device from the central server, wherein the current electronic scratch off game corresponds to the geographic location identifier;
displaying a foreground image to a user of the mobile device;
receiving a wiping input from the user of the mobile device on a touch screen of the mobile device;
removing a portion of the foreground image corresponding to the wiping input;
displaying background image in areas corresponding to the wiping input;
displaying a win or loss indicator; and
using the win indicator at a retail sponsor advertising location to obtain a prize or item of value.

11. The computer program of claim 10, wherein downloading the electronic scratch off game to the mobile device from the central server further comprises confirming that a game on the mobile device corresponds to the geographical location identifier.

12. The computer program of claim 10, wherein displaying the foreground image and or the background image further comprises displaying an advertising component.

13. The computer program of claim 10, wherein the win indicator comprises a discount code or a bar code that is recognizable by a retailer.

14. The computer program of claim 10, further comprising expiring the electronic scratch off game after a predetermined number of plays is reached.

15. The computer program of claim 10, further comprising maintaining a local database of win indicators on the mobile device for subsequent use.

16. The method of claim 1, were in the geographic location identifier comprises GPS coordinates, longitude and latitude information, or mobile device signal triangulation information.

17. A method for displaying targeted advertising to a user of a mobile device, comprising:
receiving a logon request from the mobile device in an advertising server, wherein the logon request includes a mobile device ID and geographic location information for the mobile device;
validating the logon request in the advertising server, and in response to the validating, sending a geographically specific scratch off game from the server to the mobile device, wherein the scratch off game includes a unique package ID;
receiving the scratch off game and the unique package ID in the mobile device, and validating the scratch off game by comparing the received unique package ID with a locally stored game package ID;
upon successful validation of the scratch off game, allowing the user to play the game, comprising:
displaying a foreground image to the user on a touch screen display of the mobile device; and
receiving a touch screen input on the mobile device and removing the foreground image in an area where the touch screen input was received, thus revealing portions of a background image to illustrate a win or loss indicator.

18. The method of claim 17, wherein sending a geographically specific scratch off game from the server to the mobile device further comprises selecting a scratch off game from a database of games using the geographic location information as a primary selection criteria.

19. The method of claim 18, further comprising selling geographically targeted advertising to advertisers for display on the mobile device when the device has a game played in an advertiser's selected geographic area.
